(19) United States
(12) Patent Application Publication
(10) Pub. No.: US 2024/0093021 A1
(43) Pub. Date: Mar. 21, 2024

(54) MULTI-PHASE SUSPENSION OF A WATER-SOLUBLE POLYMER

(71) Applicant: SNF GROUP, Andrezieux Boutheon (FR)

(72) Inventors: Cédrick FAVERO, Andrezieux Boutheon (FR); Renaud SOUZY, Andrezieux Boutheon (FR); Olivier BRAUN, Andrezieux Boutheon (FR)

(73) Assignee: SNF GROUP, Andrezieux Boutheon (FR)

(21) Appl. No.: 18/255,283

(22) PCT Filed: Dec. 13, 2021
(86) PCT No.: PCT/FR2021/052309

§ 371 Date: May 31, 2023

(30) Foreign Application Priority Data
Dec. 16, 2020 (FR) 2013351

(51) Int. Cl. C08L 33/26; C08J 3/11

(52) U.S. Cl. CPC C08L 33/26; C08J 3/11; C08J 2333/26; C08J 2433/26

(57) ABSTRACT

The present invention relates to a multiphase suspension of at least one synthetic water-soluble polymer with a weight-average molecular weight greater than or equal to 1 million daltons.

The present invention also relates to the use of this multiphase suspension for the treatment of industrial water, the treatment of municipal water, enhanced oil recovery in deposits, hydraulic fracturing, the treatment of mining effluents, drilling operations in civil engineering, drilling operations in the oil industry, drilling operations in the gas industry, the manufacture of paper or cardboard sheets, agriculture, textiles, detergents, or cosmetics.

### FIELD OF INVENTION

The present invention relates to a concentrated multiphase suspension of water-soluble synthetic polymer particles of high molecular weight used as rheology modifiers, flocculants, suspending agents or friction reducers in multiple applications such as the treatment of industrial and municipal water, enhanced oil recovery in a deposit, hydraulic fracturing, treatment of mining effluents, drilling operations in civil engineering and oil and gas operations, manufacture of sheets of paper and cardboard, agriculture, textiles, detergents, cosmetics.

### PRIOR ART OF THE TECHNIQUE

Synthetic water-soluble polymers of high molecular weight are commonly used in many applications due, in particular, to their flocculant, thickening or friction-reducing properties. Indeed, these polymers can be used in the oil and gas industry, hydraulic fracturing, papermaking processes, sludge dewatering, water treatment, construction, mining, cosmetics, agriculture, textile and detergent industry.

For example, the flocculant nature of these high molecular weight water-soluble synthetic polymers is put to use in the field of water treatment/sludge dewatering. Indeed, after an optional coagulation step where the colloidal particles present (similar to spheres smaller than 1 micrometer) are destabilized, flocculation represents the step where the particles are gathered into high-weight aggregates to generate rapid sedimentation. The water-soluble polymers thus used for water treatment are mainly in the form of powder or water-in-oil inverse emulsion. The physical properties of the flocculant are modulated depending on the water to be treated. Thus, the ionic character (nonionic, anionic, cationic, amphoteric, zwitterionic), the molecular weight or even the structure (linear or structured, even crosslinked) of the water-soluble polymer can be adapted.

The rheology-modifying nature of these polymers can be exploited in the field of enhanced oil recovery (EOR). The effectiveness of water injection sweeping is generally improved by the addition of high molecular weight water-soluble synthetic (co)polymers. The expected, and proven, benefits of the use of these (co)polymers, through the “viscosification” of water injected into an underground formation, are the improvement of sweeping and the reduction of the viscosity contrast between fluids to control their mobility in the subterranean formation in order to recover oil quickly and efficiently. These (co)polymers increase the viscosity of water.

It is also known that high molecular weight water-soluble polymers can act as a friction reducer in aqueous solutions. The stretching of the polymer chains in solution makes it possible to delay the turbulent regime established during the transport of the fluid at high speed. The consequence is a reduction in the energy required to transport the aqueous solution. In the field of hydraulic fracturing, these polymers can also act as a rheology modifier and/or as a suspending agent for proppants, for example sand.

Finally, these polymers can also generate viscosity and induce suspensivating properties in aqueous formulations used in the cosmetics, detergent and industrial hygiene, textile and agricultural industries.

Synthetic water-soluble polymers of high molecular weight can be obtained according to all the polymerization techniques well known to a person skilled in the art. This may, in particular, include polymerization in solution; gel polymerization; precipitation polymerization; emulsion polymerization (direct or reverse); suspension polymerization; reactive extrusion polymerization; water-in-water polymerization; or micellar polymerization.

Polymerization is generally free radical polymerization, preferably by inverse emulsion polymerization or gel polymerization. In free radical polymerization, we include free radical polymerization initiated by means of UV, azo, redox or thermal initiators, as well as controlled radical polymerization (CRP) techniques or matrix polymerization techniques.

Depending on the polymerization technique chosen, the (co)polymer may be in liquid or solid form (powder or microbeads), in the form of an aqueous dispersion, an inverse emulsion or a suspension (suspension of particles in oil).

For questions of logistics, transport and supply of flocculants, thickeners, or friction reducers, whatever the intended application, the preferred physical forms of these water-soluble polymers are powder or microbeads because they provide a high percentage by weight of active material.

The physical powder form of these polymers may be obtained by drying, thermo-drying, spray drying and drum drying. However, their re-dissolution requires appropriate equipment, for example a grinding unit in a wet environment for powders such as a PSU (“Polymer Slicing Unit”).

Inverse emulsions are interesting but they require rigorous optimization of their formulation so that their inversion in an aqueous medium is the fastest and their stability (during storage and transport) is guaranteed (in particular during freeze/thaw cycles).

These water-soluble polymers of high molecular weights may be obtained in the form of an aqueous dispersion according to a process called polymerization in aqueous dispersion. The polymer is polymerized directly in an aqueous solution comprising at least one compound chosen from a mineral salt, an organic salt, a dispersing organic polymer and mixtures thereof.

Another technique, as described in application WO 2018/154219, consists in formulating an aqueous dispersion of high molecular weight water-soluble polymers by dispersing solid polymer particles in an aqueous solution comprising at least one compound chosen from a mineral salt, an organic salt, a dispersing organic polymer, a viscosifying rheology modifier, and mixtures thereof.

Another technique consists in formulating a particulate suspension of high molecular weight water-soluble polymers by dispersing solid polymer particles in an oily or solvent phase.

However, whatever the technique used to obtain it, the aqueous or oily dispersion/suspension of high molecular weight water-soluble polymers is particularly unstable, viscous and poorly resistant to freeze/thaw cycles. These aqueous or oily or solvent-based dispersions/suspensions of polymers present storage and stability problems, in particular at low temperature (freezing), even if they are prepared, not by dispersion polymerization, but by dispersion of polymer particles in a brine containing, among other things, balancing agents such as dispersant polymers.

Oily suspensions are also little used because oils are not recommended, or even prohibited, for certain applications for ecological reasons and also because these suspensions additionally present pumpability problems.

### DISCLOSURE OF THE INVENTION

As the world market for flocculants, rheology modifiers and synthetic friction reducers is booming, it is necessary to have water-soluble synthetic polymers of high molecular weight whose implementation (high percentage of active ingredient, pumpability) and stability, make it possible to meet the needs and specificities of the various applications envisaged.

Faced with these needs, the applicant discovered, surprisingly, a new multiphase suspension of synthetic water-soluble polymers of high molecular weight. This multiphase suspension is prepared by dispersing and concentrating solid particles of high molecular weight water-soluble polymers using an innovative process in a mixture comprising a brine and a lipophilic apolar solvent to which other additives are added.

This multiphase suspension of polymer particles is particularly stable, whether over time or at low temperature (low settling, little creaming, no increase in viscosity). It is also resistant to freeze/thaw cycles. It has the advantage of having a high limit threshold of polymer particles that can be incorporated and dispersed (this threshold is defined by the limit from which destabilization of the formulation is observed, which results in gelation). Finally, the viscosity of this multiphase suspension remains low despite a mass concentration of polymer greater than 10%.

In addition, the carbon footprint of this multiphase solution is reduced because its preparation does not require heating and, therefore, no use of heat transfer fluid, but also because its oil content is low, and its polymer concentrated form implies less transportation costs, not to mention the lack of dissolving equipment for its use.

Therefore, a first aspect of the invention relates to a multiphase suspension MS of at least one synthetic water-soluble polymer P having a weight-average molecular weight greater than or equal to 1 million daltons, prepared according to a process comprising the following steps:
a) an oily suspension O is prepared by adding in a lipophilic apolar solvent (advantageously under stirring) 40 to 80% by weight of particles of average size less than or equal to 300 μm of at least one synthetic water-soluble polymer P and 0.5% to 5.0% by weight of at least one emulsifying agent, the percentages being expressed by weight relative to the weight of lipophilic apolar solvent,
b) a brine B is prepared by adding to water 30 to 60% by weight of at least one calcium halide and 0.05 to 1.50% by weight of at least one rheology modifier, the percentages being expressed by weight relative to the weight of water,
c) the brine B and the oily suspension O are mixed in order to obtain a multiphase suspension Msa containing 10 to 65% by weight of synthetic water-soluble polymer P, the percentages being expressed by weight relative to the weight of the multiphase suspension Msa,
d) a multiphase suspension MS is prepared by adding to the multiphase suspension Msa 0.1 to 4.0% by weight of an inverting agent, the percentages being expressed by weight relative to the weight of the multiphase suspension Msa.

Another aspect of the invention relates to the use of this multiphase suspension MS of particles of synthetic water-soluble polymer P for the treatment of industrial water, the treatment of municipal water, enhanced oil recovery in a deposit, hydraulic fracturing, the treatment of mining effluents, drilling operations in civil engineering, drilling operations in the oil industry, drilling operations in the gas industry, the manufacture of paper or cardboard sheets, agriculture, textiles, detergents, or cosmetics.

As used here, the term “water-soluble polymer” denotes a polymer which yields an aqueous solution without insoluble particles when dissolved under stirring for 4 hours at 25° C. and with a concentration of 20 g·L⁻¹ in water.

According to the present invention, the “weight-average molecular weight” of the synthetic water-soluble polymer P is determined by measuring the intrinsic viscosity. The intrinsic viscosity can be measured by methods known to a person skilled in the art and can, in particular, be calculated from the values of reduced viscosity for different concentrations by a graphical method consisting in plotting the values of reduced viscosity (on the y-axis) as a function of the concentrations (on the x-axis) and by extrapolating the curve to a zero concentration. The intrinsic viscosity value is read on the y-axis or using the least squares method. Then the weight-average molecular weight can be determined by the famous Mark-Houwink equation:

[η]=KM^{α}
[η] represents the intrinsic viscosity of the polymer determined by the solution viscosity measurement method,
K represents an empirical constant,
M represents the molecular weight of the polymer,
α represents the Mark-Houwink coefficient
α and K depend on the particular polymer-solvent system. Tables known to a person skilled in the art give the values of a and K according to the polymer-solvent system.

The synthetic water-soluble polymer P contained in the multiphase suspension MS of the invention has an average molecular weight advantageously greater than or equal to 1 million daltons.

Preferably, the average molecular weight is between 1 and 40 million daltons, more preferably between 5 and 30 million daltons.

The term “polymer” denotes both homopolymers and copolymers.

Preferably, the synthetic water-soluble polymer P is obtained from the following nonionic and/or anionic and/or cationic and/or zwitterionic water-soluble monoethylenically unsaturated monomers:
the nonionic monomers are advantageously chosen from the group comprising acrylamide, methacrylamide, N-alkylacrylamides, N-alkylmethacrylamides, N,N-dialkylacrylamides, N,N-dialkylmethacrylamides, alkoxylated esters of acrylic acid, alkoxylated esters of methacrylic acid, N-vinylpyridine, N-vinylpyrrolidone, hydroxyalkylacrylates, hydroxyalkyl methacrylates, preferably acrylamide,
the anionic monomers are advantageously chosen from the group comprising monomers having a carboxylic function and their salts including acrylic acid, methacrylic acid, itaconic acid, maleic acid; monomers having a sulphonic acid function and their salts, including acrylamido tert-butyl sulphonic acid (ATBS), allyl sulphonic acid and methallyl sulphonic acid and their salts; monomers having a phosphonic acid function and their salts; preferably chosen from acrylic acid, acrylamido tertio butyl sulphonic acid (ATBS) and their alkali metal or alkaline-earth or ammonium salts,
the cationic monomers are advantageously chosen from the group comprising quaternized or salified dimethylaminoethyl acrylate (ADAME), quaternized or salified dimethylaminoethyl methacrylate (MADAME), diallyldimethylammonium chloride (DADMAC), acrylamidopropyltrimethylammonium chloride (APTAC), methacrylamidopropyltrimethylammonium chloride (MAPTAC),
the zwitterionic monomers are advantageously chosen from the group comprising sulfobetaine monomers such as sulfopropyl dimethylammonium ethyl methacrylate, sulfopropyl dimethylammonium propylmethacrylamide, sulfopropyl 2-vinylpyridinium; phosphobetaine monomers, such as phosphato ethyl trimethylammonium ethyl methacrylate; carboxybetaine monomers.

In general, and unless otherwise indicated, the alkyl or alkoxyl groups denote linear or branched groups and advantageously having 1 to 5 carbon atoms, more advantageously 1 to 3 carbon atoms.

In general, the quaternization or the salification of the monomers is advantageously obtained from alkyl halides, for example methyl chloride, or from an acid, for example hydrochloric acid.

The synthetic water-soluble polymer P may be a (co)polymer prepared from the monomers described above and, optionally, in combination with monomers chosen from hydrophobic monomers, for example styrene, alkyl acrylates, alkyl methacrylates, aryl-acrylates, aryl-methacrylates, hydrophobic derivatives of acrylamide, amphiphilic monomers, for example dodecyl poly(oxyethylene) methacrylate, behenyl poly(oxyethylene) methacrylate, or from natural polymers such as for example, cellulose derivatives, polysaccharides, clays. In the case of hydrophobic monomers, the alkyl groups denote linear or branched groups and advantageously having 6 to 14 carbon atoms, more advantageously 6 to 10 carbon atoms. Furthermore, the aryls advantageously comprise 6 to 14 carbon atoms, more advantageously 6 to 10 carbon atoms.

The synthetic water-soluble polymer P particles may be obtained using any polymerization technique well known to a person skilled in the art. It can, in particular, be a polymerization in solution; a gel polymerization; a precipitation polymerization; an emulsion polymerization (direct or reverse); a suspension polymerization; a reactive extrusion polymerization; a water-in-water polymerization; or a micellar polymerization.

The particulate physical form of these polymers may be achieved by drying, heat-drying, spray-drying, and drum-drying a liquid polymer.

The synthetic water-soluble polymer P may be linear or structured. The term “structured” means that the polymer may be in the form of a branched polymer, in the form of a comb or in the form of a star.

The synthetic water-soluble polymer P may also be structured by at least one structural agent, which can be chosen from the group comprising polyethylenically unsaturated monomers (i.e., having at least two unsaturated functions), such as, for example, vinyl, allyl, acrylic and epoxy functions. Mention may be made, for example, of methylene bis acrylamide (MBA), triallylamine, tetraallylammonium chloride and 1,2-dihydroxyethylene bis-(N-acrylamide).

For the steps of the process for preparing the multiphase suspension MS, the addition of the various ingredients may be done under stirring. Advantageously, the synthetic water-soluble polymer P particles and the emulsifying agent are added to the lipophilic apolar solvent.

For step a) of the process for preparing the multiphase suspension MS, 40 to 80% by weight of particles of at least polymer P are added in a lipophilic apolar solvent, preferably 50 to 70% of particles of at least one polymer P. As already indicated, the percentages by weight are determined with respect to the weight of apolar solvent.

The synthetic water-soluble polymer P particles have an average size less than or equal to 300 μm, preferably from 0.1 μm to 300 μm and more preferably from 1 μm to 300 μm. The average size of the particles may be determined by any method known to a person skilled in the art, such as, for example, binocular microscopy.

According to a particular embodiment, step a) implements the addition of 50% to 70% by weight of particles of at least one synthetic water-soluble polymer P of average size between 0.1 μm and 300 μm and 1.0% to 2.0% by weight of at least one emulsifying agent.

The lipophilic apolar solvent of step a) is advantageously chosen from mineral oils (containing saturated hydrocarbons such as paraffins, isoparaffins or cycloparaffins) and/or synthetic oils.

The emulsifying agent of step a) of the process for preparing the multiphase suspension MS is preferably chosen from sorbitan esters, polyethoxylated sorbitan esters, diethoxylated oleocetyl alcohol, polyesters having an average molecular weight of between 1000 and 3000 daltons resulting from the condensation between a poly(isobutenyl) succinic acid or its anhydride and a polyethylene glycol, block copolymers with an average molecular weight of between 2500 and 3500 daltons resulting from the condensation between hydroxystearic acid and a polyethylene glycol, ethoxylated fatty amines, di-alkanol amide derivatives, stearyl methacrylate copolymers, and mixtures of all these emulsifying agents.

For step a), 0.5 to 5.0% by weight of an emulsifying agent is added, preferably 1.0 to 2.0% by weight. The percentages by weight are determined relative to the weight of lipophilic apolar solvent.

In general, the order of addition of the respective constituents of the oily suspension O (step a)), the brine B (step b)), the multiphase suspension Msa (step c)) or the multiphase suspension Msa (step d)) is not important. However, it is preferable to follow the order indicated above, in particular by adding the synthetic water-soluble polymer P, then the emulsifying agent in the lipophilic apolar solvent to form the oily suspension O.

For the preparation of the brine B (step b) of the process for preparing the multiphase suspension MS), the calcium halide is advantageously calcium chloride or calcium bromide or a mixture thereof. According to a particular embodiment, the brine B does not comprise salt of an alkali metal and/or salt of an alkaline-earth metal other than calcium. According to another particular embodiment, the brine consists of water and a calcium halide, advantageously of water and calcium chloride.

Brine B is advantageously prepared by adding 30 to 60% by weight of calcium halide in water, preferably 40 to 50% by weight. Weight percentages are determined by the weight of water.

The brine rheology modifier B is preferably chosen from hydroxyethylcellulose, attapulgite, laponite, hectorite, fumed silicas and mixtures thereof. These agents may be in micronized form, i.e., in the form of particles of size between 0.1 and 100 μm before the preparation of the oily suspension O.

For step b), 0.05% to 5.0% by weight of a rheology modifier is added, preferably 0.1 to 1.0% by weight. Weight percentages are determined by the weight of water.

For step c) of the process for preparing the multiphase suspension MS, the multiphase suspension Msa comprises 10% to 65% by weight of particles of at least one synthetic water-soluble polymer P, preferably 15% to 55% by weight of particles of synthetic water-soluble polymer P. The percentages are expressed by weight relative to the weight of the multiphase suspension Msa.

For step d) of the process for preparing the multiphase suspension MS, the reversing agent is preferably chosen from ethoxylated nonylphenols, preferably having 4 to 10 ethoxylations (i.e., preferably having a degree of ethoxylation ranging from 4 to 10); ethoxylated/propoxylated alcohols preferably having an ethoxylation/propoxylation comprising 12 to 25 carbon atoms; ethoxylated tridecyl alcohols; ethoxylated/propoxylated fatty alcohols; ethoxylated sorbitan esters (advantageously having 20 molar equivalents of ethylene oxide); polyethoxylated sorbitan laurate (advantageously having 20 molar equivalents of ethylene oxide); polyethoxylated castor oil (advantageously having 40 molar equivalents of ethylene oxide); decaethoxylated oleodecyl alcohol; heptaoxyethylated lauryl alcohol; polyethoxylated sorbitan monostearate (advantageously having 20 molar equivalents of ethylene oxide); polyethoxylated alkyl phenols (advantageously having 10 molar equivalents of ethylene oxide) cetyl ether; polyethylene oxide alkyl aryl ether; N-cetyl-N-ethyl morpholinium ethosulfate; sodium lauryl sulphate; the products of condensation of fatty alcohols with ethylene oxide (advantageously having 10 molar equivalents of ethylene oxide); the condensation products of alkylphenols and ethylene oxide (advantageously having 12 molar equivalents of ethylene oxide); condensation products of fatty amines with 5 or more molar equivalents of ethylene oxide (preferably 5 to 50 equivalents); ethoxylated tristyryl phenols; condensates of ethylene oxide with partially esterified polyhydric alcohols with fatty chains as well as their anhydrous forms; amine oxides advantageously having alkyl polyglucosides; glucamide; phosphate esters; alkylbenzene sulfonic acids and their salts; and surfactant water-soluble polymers. The reversing agent may also be a mixture of one or more of these reversing agents. The alkyl groups of these reversing agents denote linear or branched groups and advantageously having 1 to 20 carbon atoms, more advantageously 3 to 15 carbon atoms. Furthermore, the aryls of these reversing agents advantageously comprise 6 to 20 carbon atoms, more advantageously 6 to 12 carbon atoms.

During step d), 0.1 to 4.0% by weight of an inverting agent are mixed with the multiphase suspension Msa, preferably 0.2 to 2.0%. The percentages by weight are determined with respect to the weight of the multiphase suspension Msa (oily suspension O+brine B).

Optionally, at least one co-solvent may be added to the multiphase suspension MS obtained during step d) of the process. This co-solvent is advantageously a lipophilic apolar solvent, more advantageously chosen from mineral oils (containing saturated hydrocarbons such as paraffins, isoparaffins or cycloparaffins) and/or synthetic oils or a polar solvent chosen from alcohols, ethoxylated alcohols, these alcohols being linear or branched and advantageously having 1 to 5 carbon atoms.

Another aspect of the invention relates to the use of said multiphase suspension MS of particles of at least one synthetic water-soluble polymer P for the treatment of industrial water, for the treatment of municipal water, enhanced oil recovery in a deposit, hydraulic fracturing, treatment of mining effluents, drilling operations in civil engineering, drilling operations in the oil field, drilling operations in the gas field, manufacture of paper or cardboard sheets, agriculture, textiles, detergents, or cosmetics.

### EXAMPLES OF EMBODIMENTS OF THE INVENTION

The following examples illustrate the invention without, however, limiting its scope.

### Example 1: Preparation and Comparison of the Stability of a Multiphase Suspension of Water-Soluble Polymer Particles and of an Oily Suspension of Water-Soluble Polymer

a) Preparation of a Multiphase Suspension and an Oily Suspension of Water-Soluble Polymer Particles.

The synthetic water-soluble polymer P1 is a copolymer of acrylamide and sodium acrylate, containing 30 mol % of sodium acrylate. The copolymer before preparation of the suspensions is in the form of a powder whose particle size is between 5 μm and 300 μm and the content of active material (polymer) is 90% by weight. Polymer P1 has a weight-average molecular mass of 15 million daltons.

The multiphase suspension MS1 containing 50% by weight of polymer P1 is prepared according to the method of the invention: an oily suspension is prepared by adding to a mineral oil under stirring 60% by weight of polymer particles P1 and 1.5% by weight of an emulsifying agent, then a solution of calcium chloride, containing attapulgite, is added to the oily suspension to obtain a multiphase suspension. The last step in the preparation is to add the inverting agent (ethoxylated alcohol (8 ethoxylations)).

The oily suspension OS1 containing 50% by weight of polymer P1 is prepared by suspending particles of P1 in mineral oil to which the other ingredients have been added:

TABLE 1

Quantities (% by weight)

| Ingredients | MS1 | OS1 |
|---|---|---|
| Mineral oil (Exxsol ® D100S) | 15.48 | 42.72 |
| Sorbitan monoleate | 1.00 | 1.00 |
| Polymer P1 | 55.55 | 55.55 |
| CaCl₂, 35% by weight in water | 22.24 | 0 |
| CaCl₂, 2H₂O (powder) | 5.02 | 0 |
| Ethoxylated alcohol (8 ethoxylations) | 0.52 | 0.52 |
| Attapulgite | qsp | qsp |
| Total | 100.00 | 100.00 |

Table 1 (qsp: quantity sufficient for)

b) Evaluation of the Dynamic Stability of the Multiphase Suspension and of the Oily Suspension of Water-Soluble Polymer

The dynamic stability of the MS1 and OS1 suspensions was characterized by measuring the sedimentation rate. The equipment used is the LUMISizer® marketed by LUM GMBmbH. The LUMISizer® is an analytical centrifuge which allows the stability of polymer suspensions to be determined in an accelerated manner. Thanks to a very high performance optical system, the LUMISizer® makes it possible to analyze the sedimentation and/or creaming velocities of solid polymer particles. This speed is expressed in mm/month. The higher this value, the less stable the dispersion (see Table 2).

TABLE 2

| Suspension | Sedimentation rate (mm/month) |
|---|---|
| MS1 | 12 |
| OS1 | 31 |

Table 2

c) Evaluation of the Stability to Freeze/Thaw Cycles

The MS1 and OS1 suspensions underwent 3 cycles of temperature rise to 30° C. and fall to −30° C. The visual observations of the different suspensions are described in Table 3.

TABLE 3

| | After 1 | After 2 | After 6 |
|---|---|---|---|
| | freeze/thaw | freeze/thaw | freeze/thaw |
| Suspension | cycle | cycles | cycles |
| MS1 | Homogeneous, | Homogeneous, | Homogeneous, |
| | fluid | fluid | fluid |
| | and pumpable | and pumpable | and pumpable |
| OS1 | Homogeneous, | Homogeneous | Gelled |
| | fluid | viscous | |
| | and pumpable | | |

Table 3

This example demonstrates that the multiphase dispersion of polymer MS1 is more stable than the oily suspension OS1. It also demonstrates that the multiphase suspension MS1 retains its homogeneity, its fluidity, and its pumpability, even after several freeze/thaw cycles, unlike the oily suspension OS1 which becomes viscous after only 2 freeze/thaw cycles and then gels after 6 freeze/thaw cycles.

### Example 2: Preparation and Comparison of the Stability of a Multiphase Suspension of Water-Soluble Polymer Particles and of an Aqueous Dispersion of Water-Soluble Polymer

a) Preparation of a Multiphase Suspension and an Aqueous Dispersion of Water-Soluble Polymer Particles.

The synthetic water-soluble polymer P2 is an acrylamide, a sodium acrylate (20 mol %) and a sodium acrylamido tert-butyl sulfonate (5 mol %) terpolymer. The copolymer before preparation of the suspensions/dispersions is in the form of a powder whose particle size is between 5 μm and 300 μm and content of active material (polymer) is 90% by weight. Polymer P1 has a weight-average molecular mass of 24 million daltons.

The multiphase suspension MS2 containing 15% by weight of polymer P2 is prepared according to the method of the invention (same protocol as for MS1)

The aqueous suspension AS1 containing 15% by weight of polymer P1 is prepared by dispersing particles of P2 in the brine to which the other ingredients have been added.

TABLE 4

Quantities (% by weight)

| Ingredients | MS2 | AS2 |
|---|---|---|
| Mineral oil (Exxsol ® D100S) | 6.43 | 0.00 |
| Sorbitan monoleate | 0.30 | 0.00 |
| Polymer P1 | 16.66 | 16.66 |
| CaCl₂, 35% by weight in water | 61.96 | 68.20 |
| CaCl₂, 2H₂O (powder) | 14.38 | 14.89 |
| Ethoxylated alcohol (8 ethoxylations) | 0.50 | 0.00 |
| Attapulgite | qsp | qsp |
| Total | 100.00 | 100.00 |

Table 4

b) Evaluation of the Dynamic Stability of Water-Soluble Polymer Suspensions/Dispersions

The dynamic stability of the MS2 suspension and of the AS2 dispersion was characterized by measuring the sedimentation rate (as for example 1).

TABLE 5

| Dispersion/Suspension | Sedimentation rate (mm/month) |
|---|---|
| MS2 | 12 |
| AS2 | 33 |

Tableau 5

This new example demonstrates that the multiphase suspension of the invention of polymer P2 containing 15% by weight of polymer (MS2) is more stable than the aqueous dispersion AS2 (also containing 15% by weight of P2).

### Example 3: Preparation and Comparison of the Viscosity of a Multiphase Suspension of Water-Soluble Polymer and of an Inverse Emulsion of Water-Soluble Polymer

a) Preparation of the Multiphase Suspension and the Inverse Emulsion of Water-Soluble Polymer.

The multiphase suspension MS1 of example 1 is used here (prepared according to the same protocol).

The inverse emulsion IE1 containing 50% by weight of polymer P1 (from Example 1) is prepared by controlled radical polymerization in inverse emulsion according to a method known to a person skilled in the art.

b) Evaluation of the Stability

The observations and viscosity measurements (12 rpm, ambient T°, LV3 module) are collated in Table 6.

TABLE 6

| Suspension/ | Viscosity | Viscosity at | Viscosity at |
|---|---|---|---|
| Emulsion | at t0 | t = 1 month | t = 6 months |
| MS1 | 980 cps | 1050 cps | 1100 cps |
| | | Homogenous | Homogenous |
| | | Pumpable | Pumpable |
| IE1 | 1800 cps | 1850 cps | 2000 cps |
| | | Homogenous | Homogenous |
| | | Pumpable | Viscous |

Table 6

This example demonstrates that the multiphase dispersion MS1 containing 50% by weight of polymer P1 is more stable and more fluid than the inverse emulsion IE1 (containing 50% by weight of polymer P1). It also demonstrates that the multiphase suspension MS1 retains its homogeneity, its fluidity, and its pumpability, even after several months, unlike the inverse emulsion IE1 which becomes viscous and not pumpable after 6 months.

1. A multiphase suspension MS of at least one synthetic water-soluble polymer P with a weight-average molecular weight greater than or equal to 1 million daltons, prepared according to a process comprising the following steps:
a) an oily suspension O is prepared by adding, in a lipophilic apolar solvent, 40% to 80% by weight of particles having an average size of less than or equal to 300 μm of at least one synthetic water-soluble polymer P, and 0.5% to 5.0% by weight of at least one emulsifying agent, the percentages being expressed by weight relative to the weight of the lipophilic apolar solvent,
b) a brine B is prepared by adding to water 30% to 60% by weight of at least one calcium halide and 0.05% to 1.50% by weight of at least one rheology modifier, the percentages being expressed by weight relative to the weight of the water,
c) the brine B and the oily suspension O are mixed in order to obtain a multiphase suspension MSa containing 10% to 65% by weight of synthetic water-soluble polymer P, the percentages being expressed by weight relative to the weight of the multiphase suspension MSa,
d) a multiphase suspension MS is prepared by adding to the multiphase suspension MSa 0.1% to 4.0% by weight of an inverting agent, the percentages being expressed by weight relative to the weight of the multiphase suspension MSa.

2. The multiphase suspension MS according to claim 1, wherein the synthetic water-soluble polymer P is obtained from the following nonionic and/or anionic and/or cationic and/or zwitterionic water-soluble monoethylenically unsaturated monomers:
the nonionic monomers being chosen from the group consisting of acrylamide, methacrylamide, N-alkylacrylamides, N-alkylmethacrylamides, N,N-dialkylacrylamides, N,N-dialkyl methacrylamides, alkoxylated esters of acrylic acid, alkoxylated esters of methacrylic acid, N-vinylpyridine, N-vinylpyrrolidone, hydroxyalkylacrylates, hydroxyalkyl methacrylates,
the anionic monomers being chosen from the group consisting of monomers having a carboxylic function and their salts including acrylic acid, methacrylic acid, itaconic acid, maleic acid; monomers having a sulphonic acid function and their salts, including acrylamido tert-butyl sulphonic acid (ATBS), allyl sulphonic acid and methallyl sulphonic acid and their salts; monomers having a phosphonic acid function and their salts,
the cationic monomers being chosen from the group consisting of quaternized or salified dimethylaminoethyl acrylate (ADAME); quaternized or salified dimethylaminoethyl methacrylate (MADAME); diallyldimethylammonium chloride (DADMAC); acrylamidopropyl trimethylammonium chloride (APTAC); methacryl amido propyl trimethylammonium chloride (MAPTAC),
the zwitterionic monomers being chosen from the group consisting of sulfobetaine monomers such as sulfopropyl dimethyl ammonium ethyl methacrylate, sulfopropyl dimethyl ammonium propyl methacrylamide, sulfopropyl 2-vinylpyridinium; phosphobetaine monomers, such as phosphato ethyl trimethyl ammonium ethyl methacrylate; carboxybetaine monomers.

3. The multiphase suspension MS according to claim 1, wherein the emulsifying agent of step a) is chosen from sorbitan esters, polyethoxylated sorbitan esters, diethoxylated oleocetyl alcohol, polyesters having an average molecular weight of between 1000 and 3000 daltons resulting from the condensation between a poly(isobutenyl) succinic acid or its anhydride and a polyethylene glycol, block copolymers with an average molecular weight of between 2500 and 3500 daltons resulting from the condensation between the hydroxystearic acid and a polyethylene glycol, ethoxylated fatty amines, derivatives of di-alkanol amides, copolymers of stearyl methacrylate, and mixtures of these emulsifying agents.

4. The multiphase suspension MS according to claim 1, wherein the rheology modifying agent is chosen from hydroxyethylcellulose, attapulgite, laponite, hectorite, fumed silicas, and mixtures thereof.

5. The multiphase suspension MS according to claim 1, comprising a reversing agent is chosen from ethoxylated nonylphenols, preferably having 4 to 10 ethoxylations; ethoxylated/propoxylated alcohols preferably having an ethoxylation/propoxylation comprising between 12 and 25 carbon atoms; ethoxylated tridecyl alcohols; ethoxylated/propoxylated fatty alcohols; ethoxylated sorbitan esters; polyethoxylated sorbitan laurate; polyethoxylated castor oil; decaethoxylated oleodecyl alcohol; heptaoxyethylated lauryl alcohol; polyethoxylated sorbitan monostearate; polyethoxylated alkylphenol cetyl ether; polyethylene oxide alkyl aryl ether; N-cetyl-N-ethyl morpholinium ethosulfate; sodium lauryl sulphate; fatty alcohol condensation products with ethylene oxide; condensation products of alkylphenols and ethylene oxide; condensation products of fatty amines with 5 or more molar equivalents of ethylene oxide; ethoxylated tristyryl phenols; condensates of ethylene oxide with partially esterified polyhydric alcohols with fatty chains as well as their anhydrous forms; amine oxides; alkyl polyglucosides; glucamide; phosphate esters; alkylbenzene sulfonic acids and their salts; surfactant water-soluble polymers; and mixtures of several of these reversing agents.

6. The multiphase suspension MS according to claim 1, wherein step a) implements the addition of 50% to 70% by weight of particles of at least one synthetic water-soluble polymer P—having an average size of between 0.1 μm and 300 μm and 1.0% to 2.0% by weight of at least one emulsifying agent.

7. The multiphase suspension MS according to claim 1, wherein step b) implements the addition of 0.1% to 1.0% by weight of a rheology modifier.

8. The multiphase suspension MS according to claim 1, wherein the multiphase suspension MSa of step c) comprises 15% to 55% by weight of particles of water-soluble polymer P.

9. The multiphase suspension MS according to claim 1, wherein step d) implements the addition of 0.2% to 2.0% by weight of an inverting agent.

10. A method for the treatment of industrial water, the treatment of municipal water, enhanced oil recovery in a deposit, hydraulic fracturing, the treatment of mining effluents, drilling operations in civil engineering, drilling operations in the oil industry, drilling operations in the gas industry, or the manufacture of paper or cardboard sheets, agriculture, textiles, detergents, or cosmetics, said method comprising adding the multiphase suspension MS according to claim 1 to an aqueous solution.

11. The multiphase suspension MS according to claim 2, wherein the emulsifying agent of step a) is chosen from sorbitan esters, polyethoxylated sorbitan esters, diethoxylated oleocetyl alcohol, polyesters having an average molecular weight of between 1000 and 3000 daltons resulting from the condensation between a poly(isobutenyl) succinic acid or its anhydride and a polyethylene glycol, block copolymers with an average molecular weight of between 2500 and 3500 daltons resulting from the condensation between the hydroxystearic acid and a polyethylene glycol, ethoxylated fatty amines, derivatives of di-alkanol amides, copolymers of stearyl methacrylate, and mixtures of these emulsifying agents.

12. The multiphase suspension MS according to claim 2, wherein the rheology modifying agent is chosen from hydroxyethylcellulose, attapulgite, laponite, hectorite, fumed silicas, and mixtures thereof.

13. The multiphase suspension MS according to claim 3, wherein the rheology modifying agent is chosen from hydroxyethylcellulose, attapulgite, laponite, hectorite, fumed silicas, and mixtures thereof.

14. The multiphase suspension MS according to claim 11, wherein the rheology modifying agent is chosen from hydroxyethylcellulose, attapulgite, laponite, hectorite, fumed silicas, and mixtures thereof.

15. The multiphase suspension MS according to claim 14, comprising a reversing agent is chosen from ethoxylated nonylphenols, preferably having 4 to 10 ethoxylations; ethoxylated/propoxylated alcohols preferably having an ethoxylation/propoxylation comprising between 12 and 25 carbon atoms; ethoxylated tridecyl alcohols; ethoxylated/propoxylated fatty alcohols; ethoxylated sorbitan esters; polyethoxylated sorbitan laurate; polyethoxylated castor oil; decaethoxylated oleodecyl alcohol; heptaoxyethylated lauryl alcohol; polyethoxylated sorbitan monostearate; polyethoxylated alkylphenol cetyl ether; polyethylene oxide alkyl aryl ether; N-cetyl-N-ethyl morpholinium ethosulfate; sodium lauryl sulphate; fatty alcohol condensation products with ethylene oxide; condensation products of alkylphenols and ethylene oxide; condensation products of fatty amines with 5 or more molar equivalents of ethylene oxide; ethoxylated tristyryl phenols; condensates of ethylene oxide with partially esterified polyhydric alcohols with fatty chains as well as their anhydrous forms; amine oxides; alkyl polyglucosides; glucamide; phosphate esters; alkylbenzene sulfonic acids and their salts; surfactant water-soluble polymers; and mixtures of several of these reversing agents.

16. The multiphase suspension MS according to claim 1, wherein:
step a) implements the addition of 50% to 70% by weight of particles of at least one synthetic water-soluble polymer P having an average size of between 0.1 μm and 300 μm and 1.0% to 2.0% by weight of at least one emulsifying agent;
step b) implements the addition of 0.1% to 1.0% by weight of a rheology modifier;
the multiphase suspension MSa of step c) comprises 15% to 55% by weight of particles of water-soluble polymer P; and
step d) implements the addition of 0.2% to 2.0% by weight of an inverting agent.

17. The multiphase suspension MS according to claim 2, wherein:
step a) implements the addition of 50% to 70% by weight of particles of at least one synthetic water-soluble polymer P having an average size of between 0.1 μm and 300 μm and 1.0% to 2.0% by weight of at least one emulsifying agent;
step b) implements the addition of 0.1% to 1.0% by weight of a rheology modifier;
the multiphase suspension MSa of step c) comprises 15% to 55% by weight of particles of water-soluble polymer P; and
step d) implements the addition of 0.2% to 2.0% by weight of an inverting agent.

18. The multiphase suspension MS according to claim 3, wherein:
step a) implements the addition of 50% to 70% by weight of particles of at least one synthetic water-soluble polymer P having an average size of between 0.1 μm and 300 μm and 1.0% to 2.0% by weight of at least one emulsifying agent;
step b) implements the addition of 0.1% to 1.0% by weight of a rheology modifier;
the multiphase suspension MSa of step c) comprises 15% to 55% by weight of particles of water-soluble polymer P; and
step d) implements the addition of 0.2% to 2.0% by weight of an inverting agent.

19. The multiphase suspension MS according to claim 4, wherein:
step a) implements the addition of 50% to 70% by weight of particles of at least one synthetic water-soluble polymer P having an average size of between 0.1 μm and 300 μm and 1.0% to 2.0% by weight of at least one emulsifying agent;
step b) implements the addition of 0.1% to 1.0% by weight of a rheology modifier;
the multiphase suspension MSa of step c) comprises 15% to 55% by weight of particles of water-soluble polymer P; and
step d) implements the addition of 0.2% to 2.0% by weight of an inverting agent.

20. The multiphase suspension MS according to claim 15, wherein:
step a) implements the addition of 50% to 70% by weight of particles of at least one synthetic water-soluble polymer P having an average size of between 0.1 μm and 300 μm and 1.0% to 2.0% by weight of at least one emulsifying agent;
step b) implements the addition of 0.1% to 1.0% by weight of a rheology modifier;
the multiphase suspension MSa of step c) comprises 15% to 55% by weight of particles of water-soluble polymer P; and
step d) implements the addition of 0.2% to 2.0% by weight of an inverting agent.
